(19) United States
(12) Patent Application Publication
(10) Pub. No.: US 2004/0260890 A1
(43) Pub. Date: Dec. 23, 2004

(54) P-and v-semaphore operation

(76) Inventors: Jan Hoogerbrugge, Eindhoven (NL); Paul Stravers, Eindhoven (NL)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/495,402

(22) PCT Filed: Oct. 25, 2002
(86) PCT No.: PCT/IB02/04502

(51) Int. Cl. G06F 12/00

(52) U.S. Cl. 711/150; 711/141

(57) ABSTRACT

A V-operation not performed atomically for each data element or storage space that becomes available in a FIFO or a P-operation is not performed atomically for each request for a data element or a storage space in the FIFO but rather one V-operation is performed after m data elements or m storage spaces have become available in the FIFO or one P-operation is performed after m requests for data elements or m requests for storage spaces have been received. Upon using these P-operations, i.e. performing said request operations in bursts rather than atomically, cases may occur where less data elements or storage spaces are available in said FIFO buffer than needed or requested by a consumer process, e.g. a reading or a writing process. A P-operation is performed by requesting m data elements or m storage spaces for m data elements. The P-operation will only be blocked completely, if no data elements or storage spaces are available in the FIFO buffer, i.e. the semaphore counter being zero. However, if there are data elements or storage spaces available in the FIFO buffer, i.e. the semaphore counter is greater than zero, the value of the available data elements or storage spaces for data elements, i.e. the count of the semaphore counter, and the value m of the P-request operation are compared and the minimum value of said two values is selected. If there are more data elements or storage spaces available in said FIFO buffer than requested by said P-operation, the value m of the requested data elements or storage spaces for data elements is selected as the actual available decrement of said semaphore counter. However, if there are less data elements or storage spaces available in said FIFO buffer than requested by said P-operation, the value of the available data elements or storage spaces for data elements is selected as the actual available decrement dec. The actual decrement dec of said semaphore counter is finally output. According to this actual decrement dec, dec data elements can be output from said FIFO buffer or dec storage spaces are available for dec data elements, so that dec data elements can be input into the FIFO buffer.

The invention relates to a P-semaphore operation for a semaphore counter controlling access to a shared FIFO buffer; a method for reading as well as a method for writing a plurality of data elements from/into a shared FIFO buffer; a P-semaphore operation unit for decrementing a semaphore counter controlling access to the shared FIFO buffer; a device for reading a plurality of data elements from a shared FIFO buffer and a device for writing a plurality of data elements into a shared FIFO buffer; a computer system for concurrent processing with a shared FIFO buffer accessible from a reader task and a writer task and a corresponding computer program product.

In computer systems, coordination of processors is an important issue. In a centralised system semaphores are commonly used to solve many process coordination problems such as mutual exclusion and managing re-usable and consumable resources.

The problem of mutual exclusion is an important issue in concurrent processing. Multiple processes are often executed concurrently on one or more processors. The processors often share resources such as storage devices, input/output devices and memory. When two or more processes need to operate on the same data and memory, it becomes necessary to provide a mechanism to enforce mutual exclusive access to the resources. The mechanism is required to allow only one process to have access to a source at any one time.

Usually, a so-called producer-consumer problem arises in concurrent processing. The basis of the producer-consumer problem is that the producer of data must have means to store said data until the consumer is ready and the consumer must not try to consume data that is not there. It appears to be impractical for the producer to produce data only when the consumer is ready to consume. If either of these processes arrive early, it is required to wait. However, if the data rates of the consumer or the producer vary during the execution of the programme or alternatively if the data rates of the producer or the consumer are not the same, buffering the data becomes necessary. The buffer is a segment of memory, to which both the producer and the consumer have access to. If the buffer is large enough to handle peaks of data production, both producer and consumer maintain a steady high average rate of data transfer without fearing a malfunction because of occasional peaks.

When concurrent processes are linked in producer-consumer pairs and share a finite buffer where every portion is accessible to each process, the slow consumer may considerably delay the entire system. In some cases, where a consumer is blocked, the messages generated by the associate producer will invade the whole buffer and will therefore block the system. To avoid such behaviour it is known to reserve for each producer-consumer pair the adequate number of portions for normal working and to dedicate the rest of the buffer to absorb the production peaks of the various pairs.

Often the semaphore is used as synchronisation mechanism that mediates access to share resources. The semaphore has an associated value, which is generally set to the number of resources regulated by the semaphore. Each time the semaphore is acquired by the process the value of the semaphore is decremented by 1. After the value of the semaphore reaches zero, new attempts to acquire the semaphore are blocked until the semaphore is released by one of the processors and the value of the semaphore is incremented by 1.

The semaphore is a non-negative integer variable on which only P— and V-operations are allowed. A V-operation is used by a producer process to indicate that it has produced information for the use by the consumer process. A P-operation is used by a consumer process when it requests information produced by a producer process. The P-operation is used to enter mutual exclusion while the V-operation is used to exit mutual exclusion. The semaphore corresponds a counter wherein the V-operation increments said counter and the P-operation decrements said counter but blocks if said counter is zero and stays blocked until said counter becomes larger than zero. A very graphic explanation of the semaphore and the P— and V-operations can be found in U.S. Pat. No. 4,928,222.

It is an object of the present invention to provide means for controlling access to a shared FIFO buffer enabling an improved operation in a concurrent processing environment.

The object of the present invention is solved by a P-semaphore operation for a semaphore counter controlling access to a shared FIFO buffer according to claim 1; a method for reading a plurality of data elements from said shared FIFO buffer according to claim 2, a method for writing a plurality of data elements into a shared FIFO buffer according to claim 4; a P-semaphore operation unit for decrementing a semaphore counter according to claim 6; a device for reading a plurality of data elements from a shared FIFO buffer according to claim 7; a device for writing a plurality of data elements into a shared FIFO buffer according to claim 8; a computer system for concurrent processing with a shared FIFO buffer accessible from a reader task and a writer task according to claim 9, and a computer program product according to claim 10.

The invention is based on the fundamental idea to perform a V-operation not atomically for each data element or storage space that becomes available in the FIFO or to perform a P-operation not atomically for each request for a data element or a storage space in the FIFO but rather to perform one V-operation after m data elements or m storage spaces have become available in the FIFO or one P-operation after m requests for data elements or m requests for storage spaces have been received.

Upon using these P-operations, i.e. performing said request operations in bursts rather than atomically, cases may occur where less data elements or storage spaces are available in said FIFO buffer than needed or requested by a consumer process, e.g. a reading or a writing process. A P-operation is performed by requesting m data elements or m storage spaces for m data elements. The P-operation—decrementing a semaphore counter—will only be blocked completely, if no data elements or storage spaces are available in the FIFO buffer, i.e. the semaphore counter being zero. However, if there are data elements or storage spaces available in the FIFO buffer, i.e. the semaphore counter is greater than zero, the value of the available data elements or storage spaces for data elements, i.e. the count of the semaphore counter, and the value m of the P-request operation are compared and the minimum value of said two values is selected.

If there are more data elements or storage spaces available in said FIFO buffer than requested by said P-operation, the value m of the requested data elements or storage spaces for data elements is selected as the actual available decrement of said semaphore counter. However, if there are less data elements or storage spaces available in said FIFO buffer than requested by said P-operation, the value of the available data elements or storage spaces for data elements is selected as the actual available decrement dec. The actual decrement dec of said semaphore counter is finally output. According to this actual decrement dec, dec data elements can be output from said FIFO buffer or dec storage spaces are available for dec data elements, so that dec data elements can be input into the FIFO buffer.

The advantage of performing the P— and V-operations according to the invention is that several P— and V-operations can be combined into one operation in order to reduce cache coherence traffic, while ensuring that these V— and P-operations are not blocked unnecessarily.

The invention is also solved by a corresponding P-semaphore operation unit for decrementing a semaphore counter controlling access to a shared FIFO buffer, by which the above described P-semaphore operation can be implemented.

The invention is still further solved by a method for reading a plurality of data elements from a shared FIFO buffer using the P-semaphore operation for a semaphore counter controlling access to said shared FIFO buffer. When a consumer task requests permission from the P-semaphore operation to read m data elements from said FIFO buffer, the P-semaphore operation is performed as described above and outputs the available decrement dec. Said available decrement dec indicates that dec data elements are available to be read from said FIFO buffer. Thereafter, the dec data elements are read from said FIFO buffer. When the dec data elements are read from said FIFO buffer, the available decrement dec is subtracted from the count of a second counter. The above mentioned steps are iterated as long as the count m of the second counter is greater than zero.

According to a preferred embodiment, signalling that dec storage spaces for dec data elements are available is performed after dec data elements have been read from the FIFO. In other words, one V-operation indicating, that dec storage spaces for dec data elements are available in the FIFO, is performed.

The invention is still further solved by a method for writing a plurality of data elements into a shared FIFO buffer using the P-semaphore operation for a semaphore counter controlling access to said shared FIFO buffer. When a producer task requests permission from the P-semaphore operation to write m data elements into said FIFO buffer, the P-semaphore operation is performed as described above and outputs the available decrement dec. Said available decrement dec indicates that dec storage spaces for dec data elements are available in said FIFO buffer. Thereafter, dec data elements are written into said FIFO buffer according to the dec storage spaces. When the dec data elements are written into said FIFO buffer, the available decrement dec is subtracted from the count of a second counter. The above mentioned steps are iterated as long as the count m of the second counter is greater than zero.

According to a preferred embodiment, signalling that dec data elements are available is performed after dec data elements have been written into the FIFO. In other words, one V-operation indicating, that data elements are available to be read from said FIFO, is performed.

The invention is solved by corresponding reading and writing devices, which are adapted to implement the above described reading and writing methods, respectively.

The invention is also solved by a computer system for concurrent processing with a shared FIFO buffer accessible from a reader task and a writer task, comprising a P-semaphore operation unit for decrementing a semaphore counter, a device for reading a plurality of data elements from a shared FIFO buffer, and/or a device for writing a plurality of data elements into a shared FIFO buffer.

Finally, the invention is further solved by a computer program product comprising computer program code means for causing a computer to perform the steps of said reading/writing method and/or the P-semaphore operation when said computer program is run on a computer.

The invention will now be explained in more detail with reference to the drawings, in which:

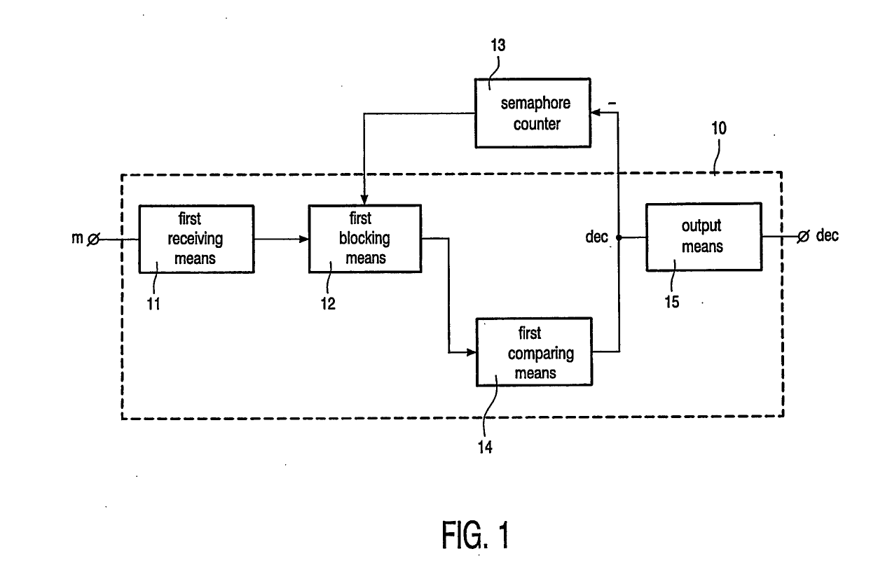

FIG. 1 shows a block diagram of a P-semaphore operation unit 10 according to a first embodiment;

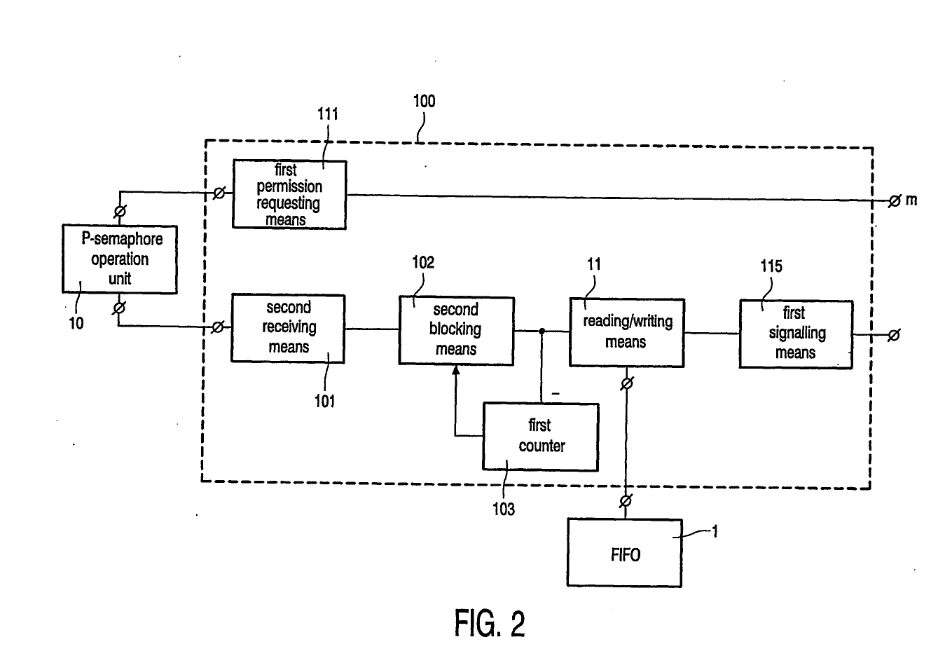

FIG. 2 shows a block diagram of a device 100 for reading a plurality of data elements from a shared FIFO buffer according to a first embodiment;

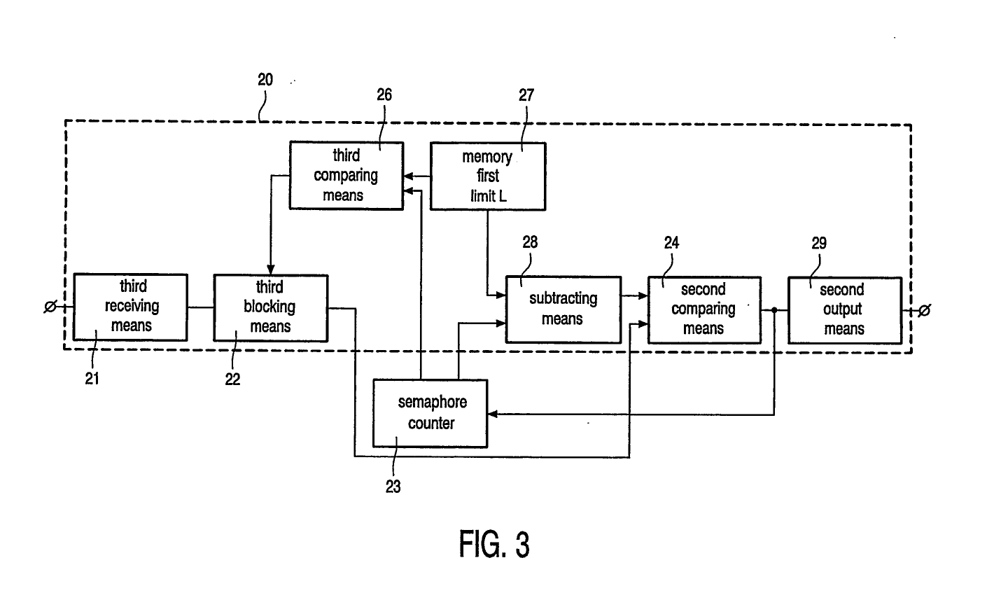

FIG. 3 shows a block diagram of a V-semaphore operation unit 20 according to a second embodiment; and

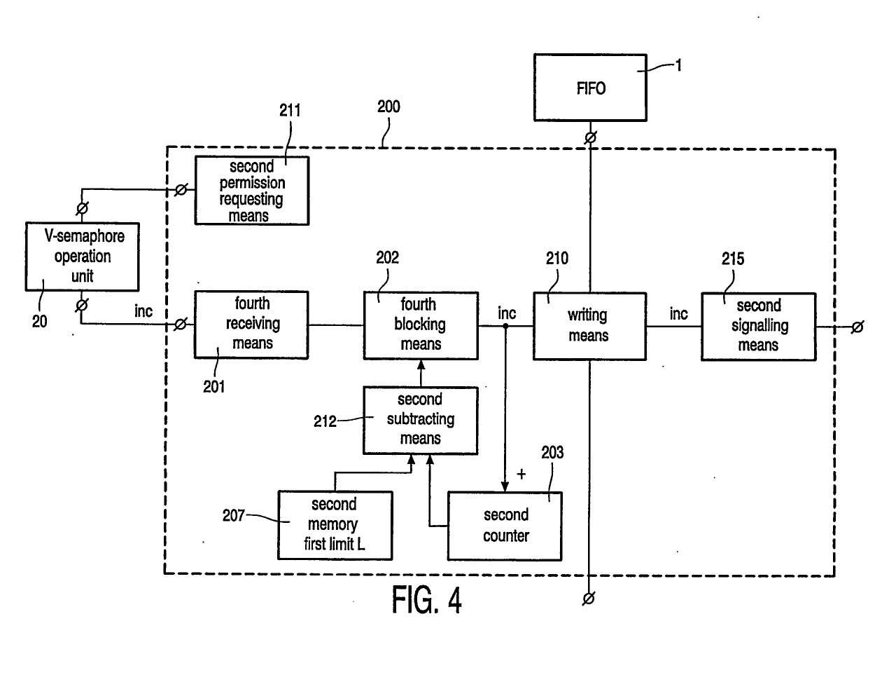

FIG. 4 shows a block diagram of a device 200 for writing a plurality of data elements into a shared FIFO buffer according to a second embodiment;

In a first embodiment, reading/writing from/to a FIFO buffer shared by at least two processes, like a reading and writing process, in a computer system based on concurrent processing is carried out by using a P-semaphore operation.

FIG. 1 shows a block diagram of a P-semaphore operation unit 10 for decrementing a semaphore counter 13 (also shown in FIG. 1), which is controlling the access to a shared FIFO buffer 1 (not shown). The semaphore counter 13 may be based on the available data elements in said FIFO buffer, i.e. a semaphore (data) or on the available storage spaces in said FIFO buffer, i.e. a semaphore (room). The P-semaphore operation unit 10 comprises a first receiving means 11, a first blocking means 12, a first comparing means 14 and a first output means 15. Said first receiving means 11 is connected to said first blocking means 12, which receives the status of said semaphore counter 13 as input signal. Said first blocking means 12 is further connected to said first comparing means 14, which in turns is connected to said semaphore counter 13. Said semaphore counter 13 outputs the status thereof to the first blocking means 12 and the first comparing means 14 and receives the output of the first comparison means 14 as an input signal. Finally, the first comparison means 14 is also connected to said output means 15.

Said first receiving means 11 receives a request by the consumer task to decrement the count n of said semaphore counter 13 m-times. Said request for m decrements of the count n of said semaphore counter 13 indicates one P-request for m data elements from said FIFO buffer 1, i.e. the semaphore counter 13 is based on the semaphore (data). Said first receiving means 11 forwards the request for m decrements to said first blocking means 12, which blocks said request for m decrements when the count n of said semaphore counter 13 equals Zero. When the count n of said semaphore counter 13 is greater than zero, said first blocking means 12 forwards said request for m decrements to said first comparing means 14, which compares the forwarded request for m decrements and the count n of said semaphore counter 13 in order to determine the minimum value of said two values. The count n of said semaphore counter 13 is decremented by the minimum value as determined in said first comparing means 14. Said minimum value as determined in said first comparing means 14 is forwarded to said output means 15 to be output as the available decrement dec. Said available decrement dec indicates how many data elements can actually be output from said FIFO buffer 1.

Alternatively, a request for m decrements of the count n of said semaphore counter 13 from a producer task indicates one P-request for m storage spaces for m data elements in said FIFO buffer 1, i.e. the semaphore counter 13 is based on the semaphore (room). And in this case, said available decrement dec indicates how many data elements can actually be input into said FIFO buffer 1, since m storage spaces for m data elements are available.

FIG. 2 shows a block diagram for a device 100 for reading a plurality of data elements from an external shared FIFO buffer 1 as well as for a device for writing a plurality of data elements into an external shared FIFO buffer 1.

Said reading device and said writing device 100 both comprise a first permission requesting means 111, a second receiving means 101, a second blocking means 102, a first counter 103, a reading/writing means 110 and a first signalling means 115. Said first permission requesting means 111 is connected to an external P-request operation unit 10. The output of said P-request operation unit 10 is connected to the input of said second receiving means 101. Said second receiving means 101 is further connected to said second blocking means 102, which in turns is connected to said reading/writing means 110 and said first counter 103. The output of said first counter 103 is connected to said second blocking means 102. Said reading/writing means 110 is connected to the shared FIFO buffer 1 and said first signalling means 115.

Regarding the reading operation, a consumer task inputs a request for permission to read m data elements from said FIFO buffer 1 to said first permission requesting means 111. Said first permission requesting means 111 initiates a request to said P-semaphore operation unit 10 to grant permission to read m data elements from said FIFO buffer 1. Said P-semaphore operation unit 10 receives said request for m data elements and processes this request on the basis of the semaphore (data) as described above with reference to FIG. 1 and outputs the available decrement dec. Said second receiving means 101 receives of the available decrement dec as output from said P-request operation unit 10 and forwards the available decrement dec to a said second blocking means 102. Said second blocking means 102 blocks the request for dec data elements if the count m of a said first counter 103 equals 0. However, if the count m of said first counter 103 is greater than zero, the available decrement dec is forwarded to said reading/writing means 110 by said second blocking means 102. Said reading/writing means 110 reads dec data elements from said FIFO buffer 1 and outputs these dec data elements. After said dec data elements have been output by said reading/writing means 110, said reading/writing means 110 notifies said first signalling means 115, that dec data elements have been output from said FIFO buffer 1. Thereafter, said first signalling means 115 performs a signal operation, which indicates that dec storage spaces for dec data elements are available in said FIFO buffer 1. Said signal operation represents a V-operation indicating that dec storage spaces are now available in said FIFO buffer 1. Then the count m of the first counter is decremented by dec.

Alternatively, in the writing operation a producer task inputs a request for permission to write m data elements into said FIFO buffer 1 to said first permission requesting means 111. The further processing corresponds to the reading operation as described above. Said P-semaphore operation unit 10 receives said request for m storage spaces for m data elements and processes this request on the basis of the semaphore (room) as described above with reference to FIG. 1. The available decrement dec is forwarded to said reading/writing means 110 by said second blocking means 102. Thereafter, said reading/writing means 110 writes dec data elements into said FIFO buffer. After said dec data elements have been input by said reading/writing means 110, said reading/writing means 110 notifies said first signalling means 115, that dec data elements have been input into said FIFO buffer 1. Thereafter, said first signalling means 115 performs a signal operation, which indicates that dec data elements are available in said FIFO buffer 1. Hence, said signal operation represents a V-operation on the semaphore (data) indicating that dec data elements are now available to be read from said FIFO buffer 1. Then the count m of the first counter is decremented by dec.

Thus, according to the first embodiment, the reading operation is carried out by performing one P-operation for at least one data element on the semaphore (data), i.e. requesting to read data elements from the FIFO buffer, and at the end of the reading operation by performing one V-operation on the semaphore (room) for at least one storage space in said FIFO buffer, indicating that storage spaces are now available in the FIFO. On the other hand, the writing operation is carried out by performing one P-operation for at least one storage space in said FIFO buffer on the semaphore (room), i.e. requesting storage space for data elements in the FIFO buffer, and at the end of the writing operation by performing one V-operation on the semaphore (data) for at least one data element, indicating that data elements are now available to be read from the FIFO. The difference between reading and writing is that semaphore operations are performed on different semaphores, i.e. semaphore (data) and semaphore (room), and data elements are copied in opposite directions, i.e. copied to the FIFO and from the FIFO.

In a second embodiment reading/writing from/to a FIFO buffer shared by at least to processes, like a reading and writing process, in a computer system based on concurrent processing is carried out by using a V-semaphore operation.

FIG. 3 shows a block diagram of a V-semaphore operation unit 20 for incrementing a semaphore counter 23 (also shown in FIG. 3), which is controlling the access to an external shared FIFO buffer 1 (not shown). The V-semaphore operation unit 20 comprises a third receiving means 21, a third blocking means 22, a second comparing means 24, a second output means 29, a first subtracting means 28, a memory for a first limit L 27 and a third comparing means 26.

The third receiving means 21 is connected to the third blocking means 22, which in turns is connected to a second comparing means 24 and the third comparing means 26. The third comparing means 26 is connected to the memory for the first limit L 27 and said semaphore counter 23. The memory for the first limit L 27 is furthermore connected to the first subtracting means 28. The first subtracting means 28 receives the status of said semaphore counter 23 and the status of the memory 27, i.e. said first limit L, as input signals and outputs the subtracting result to the second comparing means 24. The output of the second comparing means 24 is the available increment inc, which is output by the output means 29. Said semaphore counter 23 receives the available increment inc as input.

Said first receiving means 21 receives a request by the producer task to increment the count n of said semaphore counter 23 m-times. Said request for m increments of the count n of said semaphore counter 23 indicates the request for one V-release of m data elements into said FIFO buffer 1. Said first receiving means 21 forwards said request for m increments to said third blocking means 22. Said third blocking means 22 blocks the request for m increments, if the count n of said semaphore counter 23 has exceeded a first limit L, which is stored in said memory for said first limit L 27. Said third comparing means 26 receives the first limit L and the count n of said semaphore counter 23 as input signals and compares these two input signals, in order to determine whether the count n of said semaphore counter 23 has exceeded said first limit L. Said third comparing means 26 outputs the result of this comparing operation to said third blocking means 22. If the count n of said semaphore counter 23 has not yet exceeded said first limit L as determined by said third comparing means 26, said third blocking means 22 forwards the request for m increments to said second comparing means 24.

Said first subtracting means 28 receives the first limit L and the count n of said semaphore counter 23 as input signals and subtracts the two values, in order to determine the difference thereof. Said first subtracting means 28 outputs the subtracting result to said second comparing means 24, which compares said subtracting result with the request for m increments and determines which of said to values is the minimum value. Said second comparing means 24 outputs the determined minimum value to said output means 29. Said output means 29 receives the minimum value as input signals and outputs the minimum value as the available increment inc, indicating that inc storage spaces are available for inc data elements.

FIG. 4 shows a block diagram of a device 200 for writing a plurality of data elements into a shared FIFO buffer 1. Said device 200 comprises a second permission requesting means 211, a fourth receiving means to 01, a fourth blocking means 202, a second counter 203, a writing means 210, a second signalling means 215, a second memory for the first limit L 207, and a second subtracting means 212.

Said permission requesting means 211 is connected to the input of a V-semaphore operation unit 20 and said fourth receiving means 201 is connected to the output of said V-semaphore operation unit 20. Said fourth receiving means 201 is furthermore connected to said fourth blocking means 202, which in turns is connected to said writing means 210, said second counter 203 and said second subtracting means 212. Said second subtracting means 212 is connected to said second counter 203 and said memory for said first limit L 207 on its input side and to said fourth blocking means 202 on its output side. Said writing means 210 is connected to said external shared FIFO buffer 1 and said second signalling means 215.

A producer task inputs a request for permission to write m data elements into said FIFO buffer 1 to said second permission requesting means 211. Said second permission requesting means 211 initiates a request to said V-semaphore operation unit 20 to grant permission to write m data elements into said FIFO buffer 1. Said V-semaphore operation unit 20 receives said request to write m data elements and processes this request as described above with reference to FIG. 3 and outputs the available increment inc. Said forth receiving means 201 receives the available increment inc as output from said V-request operation unit 20 and forwards the available increment inc to a said fourth blocking means 202.

Said fourth blocking means 202 blocks the request to write m data elements when the count of said second counter 203 has exceeded said first limit L. Said second subtracting means 212 receives the count m of said second counter 203 and the first limit L as input signals and subtracts these values, in order to determine whether said count m of said second counter 203 has exceeded said first limit L. When said count m of said second counter 203 has not yet exceeded said first limit L, said fourth blocking means 202 forwards the available increment inc to said writing means 210. Upon the reception of said available increment inc, said writing means 210 writes inc data elements into said FIFO buffer 1. Said writing means 210 further forwards said available increment inc to said second signalling means 215. Said second signalling means 215 performs a signalling operation indicating that inc data elements are available in said FIFO buffer 1 for further processing, i.e. a V-operation is performed on inc data elements input into said FIFO buffer 1, indicating that inc data elements are available to be read from the FIFO.

Furthermore the available increment inc is added to the count m of said second counter 203 after inc data elements are written into said FIFO buffer 1. The above mentioned steps are iterated as long as the count m of the second counter does not exceed a first limit L.

A reading operation can also be performed on the basis of a V-operation. Such a reading operation is then carried out symmetrically to the writing process as described above. With reference to FIG. 4.

A V-operation is very much similar to the above P-operation. It is to be avoided when performing said V-operation that the semaphore counter exceeds a predefined limit L. The V-operation may not allow that more data elements are input into said FIFO buffer than storage spaces are available in said FIFO buffer or that a V-operation on more than the maximum available storage spaces in the FIFO buffer is performed. The maximum available storage spaces in said FIFO buffer correspond to said predefined limit L.

As a summary it can be said, that a P-semaphore operation tries to decrement the semaphore counter m-times and returns the actual decrement which is larger than zero but not larger than the requested the government. A V-semaphore operation tries to increment the semaphore counter m-times and returns the actual increment which is larger than zero but not larger than the first limit L of said semaphore counter.

Reading from a FIFO buffer is symmetrical to writing into the FIFO buffer. In the case of reading from the FIFO, the reading process acts as a consumer process by consuming or processing data while at the same time as a producer process by producing free storage spaces in the FIFO buffer, since data elements have been output from the FIFO buffer. In the case of writing into the FIFO, the writing process acts as a consumer process by consuming or occupying storage spaces while at the same time as a producer process by producing data elements in the FIFO buffer, since data elements have been input into the FIFO buffer.

The variables 1 and/or m can be set to a predetermined value or alternatively they can be computed according to the current processing status, in order to optimise the overall processing performance.

1. P-semaphore operation for a semaphore counter (13) controlling access to a shared fifo buffer (1), comprising the steps of:
b) receiving one request by a consumer task to decrement the count n of said semaphore counter (13) m-times, said request for m decrements of the count n of said semaphore counter (13) indicating one P-request for m data elements from said FIFO buffer (1) or one P-request for m storage spaces for m data elements in said FIFO buffer (1);
c) blocking the P-request operation, if the count n of said semaphore counter (13) equals 0;
d) decrementing the count n of said semaphore counter (13) by the count n of said semaphore counter (13) or the value of the requested decrement m depending which of said two values is the minimum value; and
e) outputting said minimum value determined in step d) as the available decrement dec.

2. Method for reading a plurality of data elements from a shared FIFO buffer (1) by using a P-semaphore operation for a semaphore counter (13) controlling access to said shared FIFO buffer (1), and by using a first counter (103), comprising the steps of:
a) a consumer task requesting permission from said P-semaphore operation to read m data elements from said FIFO buffer (1);
said P-semaphore operation comprising the steps of
b) receiving one request by said consumer task to decrement the count n of said semaphore counter (13) m-times, said request for m decrements of the count n of said semaphore counter (13) indicating one P-request for m data elements from said FIFO buffer (1);
c) blocking the P-request operation, if the count n of said semaphore counter (13) equals 0;
d) decrementing the count n of said semaphore counter (13) by the count n of said semaphore counter (13) or the value of the requested decrement m depending which of said two values is the minimum value; and
e) outputting said minimum value determined in step d) as the available decrement dec
f) receiving an available decrement dec from said P-semaphore operation indicating that dec data elements are available to be read from said FIFO buffer (1);
g) reading dec data elements from the FIFO buffer (1); and
i) subtracting the available decrement dec from the count m of said first counter (103).
j) iterating the steps a) to i) as long as the count m of the first counter (103) is greater than 0.

3. Method according to claim 2, further comprising the step of:
h) signalling that storage space is available in the FIFO buffer (1) for dec data elements.

4. Method for writing a plurality of data elements into a shared FIFO buffer (1) by using a P-semaphore operation for a semaphore counter (13) controlling access to said shared FIFO buffer (1), and by using a first counter (103), comprising the steps of:
a) '1a consumer task requesting permission from said P-semaphore operation to write m data elements into said FIFO buffer (1);
said P-semaphore operation comprising the steps of
b) receiving one request by said consumer task to decrement the count n of said semaphore counter (13) m-times, said request for m decrements of the count n of said semaphore counter (13) indicating one P-request for m storage spaces for m data elements in said FIFO buffer (1);
c) blocking the P-request operation, if the count n of said semaphore counter (13) equals 0;
d) decrementing the count n of said semaphore counter (13) by the count n of said semaphore counter (13) or the value of the requested decrement m depending which of said two values is the minimum value; and
e) outputting said minimum value determined in step d) as the available decrement dec
f) receiving an available decrement dec from said P-semaphore operation indicating that dec storage spaces for dec data elements are available in said FIFO buffer (1);
g) writing dec data elements into the available dec storage spaces in said FIFO buffer (1); and
i) subtracting the available decrement dec from the count m of said first counter (103).
j) iterating the steps a) to i) as long as the count m of the first counter (103) is greater than 0.

5. Method according to claim 4, further comprising the step of:
h) signalling that data elements are available to be read from the FIFO buffer (1).

6. P-semaphore operation unit (10) for decrementing a semaphore counter (13) controlling access to a shared FIFO buffer (1), comprising:
first receiving means (11) for receiving one request by a consumer task to decrement the count n of said semaphore counter (13) m-times, said request for m decrements of the count n of said semaphore counter (13) indicating one P-request for m data elements from said FIFO buffer (1) or one P-request for m storage spaces for m data elements in said FIFO buffer (1);
first blocking means (12) for blocking the P-request operation, if the count n of said semaphore counter (13) equals 0;
first comparing means (14) for comparing the count n of said semaphore counter (13) and the value of the requested decrement m and for selecting the minimum value of said two values; and
first output means (15) for outputting said minimum value selected by said comparing means (15) as the available decrement dec.

7. Device (100) for reading a plurality of data elements from a shared FIFO buffer (1) by using a P-semaphore operation unit (10) for decrementing a semaphore counter (13) controlling access to said shared FIFO buffer (1), and by using a first counter (103), comprising:
permission requesting means (111) for requesting permission from said P-semaphore operation unit (10) to read m elements from said FIFO buffer (1);
said P-semaphore operation unit (10) comprising:
first receiving means (11) for receiving one request by a consumer task to decrement the count n of said semaphore counter (13) m-times, said request for m decrements of the count n of said semaphore counter (13) indicating one P-request for m data elements from said FIFO buffer (1);
first blocking means (12) for blocking the P-request operation, if the count n of said semaphore counter (13) equals 0;
first comparing means (14) for comparing the count n of said semaphore counter (13) and the value of the requested decrement m and for selecting the minimum value of said two values; and
first output means (15) for outputting said minimum value selected by said comparing means (15) as the available decrement dec
second receiving means (101) for receiving an available decrement dec from said P-semaphore operation unit (10) indicating that dec data elements are available to be read from said FIFO buffer (1);
reading means (1 10) for reading dec data elements from the FIFO buffer (1);
wherein the available decrement dec is subtracted from the count m of said first counter (103); and
second blocking means (102) for blocking the reading operation, when the count m of said first counter (103) equals 0.

8. Device (100) for writing a plurality of data elements into a shared FIFO buffer (1) by using a P-semaphore operation unit (10) for decrementing a semaphore counter (13) controlling access to said shared FIFO buffer (1), and by using a first counter (103), comprising:
permission requesting means (111) for requesting permission from said P-semaphore operation unit (10) to write m elements into said FIFO buffer (1);
said P-semaphore operation unit (10) comprising:
first receiving means (11) for receiving one request by a consumer task to decrement the count n of said semaphore counter (13) m-times, said request for m decrements of the count n of said semaphore counter (13) indicating one P-request m storage spaces for m data elements in said FIFO buffer (1);
first blocking means (12) for blocking the P-request operation, if the count n of said semaphore counter (13) equals 0;
first comparing means (14) for comparing the count n of said semaphore counter (13) and the value of the requested decrement m and for selecting the minimum value of said two values; and
first output means (15) for outputting said minimum value selected by said comparing means (15) as the available decrement dec
second receiving means (101) for receiving an available decrement dec from said P-semaphore operation unit (10) indicating that dec storage spaces for dec data elements are available in said FIFO buffer (1);
writing means (110) for writing dec data elements into said FIFO buffer (1);
wherein the available decrement dec is subtracted from the count m of said first counter (103); and
second blocking means (102) for blocking the writing operation, when the count m of said first counter (103) equals 0.

9. (Cancel)

10. Computer program product comprising computer program code means for causing a computer to perform the steps of the P-semaphore operation according to claim 1, when said computer program is run on a computer.
